(19) United States
(12) Patent Application Publication
(10) Pub. No.: US 2003/0014640 A1
(43) Pub. Date: Jan. 16, 2003

(54) Printer regulation through verification of a user

(76) Inventor: Travis W. Loyd, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/905,415

(22) Filed: Jul. 13, 2001

(51) Int. Cl. H04L 9/00

(52) U.S. Cl. 713/182

(57) ABSTRACT

A method and system for regulating use of a printer through key pair cryptography. A user encrypts an aspect of a print job with a private key of the user. The aspect may relate to the content of the print job and once encrypted may constitute a digital signature. The printer receives the print job, obtains a public key of the user, where the public key forms a key pair with the private key, and decodes the encrypted aspect. If decoding is successful, the printer outputs a document based on the print job. The present invention also provides for optional re-verification when the user is proximate to the printer, before the document is printed. The re-verification requires that the user prove local possession of the private key.

### FIELD OF THE INVENTION

The present invention relates to printing. More specifically, the present invention relates to regulating printer activity based on verification of a user through cryptography.

### BACKGROUND OF THE INVENTION

Maintaining a secure computer network is a fundamental concern for those that communicate information over the network. The difficulty of knowing with confidence a physical location of a network user, coupled with the invisibility of the network user, allow a dishonest user to assume a false identity. With the false identity, the user may acquire privileges that significantly disrupt the computer network. For example, the user may access and corrupt confidential information. In addition, the user may gain unauthorized access to services that are available over the network.

Printing is a service that may require reliable user identification when offered over a computer network. For example, a user might be charged for printing a document on a printer. Also, access to a printer may be a privilege that is offered to specific users. In each of these examples, use of the printer may be better regulated if the printer is able to rely on user identification. Without accurate user identification, an unscrupulous user may gain access to the printer by masquerading as another user or as a fictitious person.

As more and more users of networks become mobile, for example, through use of portable processors such as personal digital assistants and cellular phones, these users will require increased access to a larger number of printers. Thus, printers in networks would benefit from a reliable way of identifying each mobile user, to assess printing privileges of the user and to charge the correct user for use of the printer. With reliable identification, the printer could also ensure that the user who sends a print job is identical to a person who picks up a resulting printed document.

Cryptography with asymmetric key pairs provides a general solution to problems of network security. An asymmetric key pair includes a public key and a corresponding private key. The key pair provides bi-directional encrypting and decoding capabilities. Specifically, the public key is able to 1) encrypt data that is decodable with the private key, and 2) decode data that was encrypted with the private key. The public key and private key are usually very large numbers and thus may provide a unique key pair that cannot be identified easily by a trial-and-error approach.

The broad usefulness and secure nature of a key pair are determined by the differential availability of each key. The public key is not maintained as a secret and is shared widely, which allows many to use this portion of the key pair in communications with a key holder. In contrast, the security of the key pair lies with the private key. The private key itself is maintained in secret by the key holder and is not directly shared with others. Instead, proof of possession of the private key may be provided indirectly by encrypting data with the private key. The resulting encrypted data is unreadable until decoded with the corresponding public key of the key pair. Thus, only the key holder of the private key should be capable of producing encrypted data that is decodable with the corresponding public key of the key pair. Similarly, only the keyholder of the private key should be able to encrypt data to a form that is decodable with the corresponding public key.

The certainty with which a specific user or device is identified by a key pair is based on a model of trust. This model of trust uses a trusted entity, such as a person, persons, or institution, to provide an assurance that the correct identity of the user is linked to a public key. For example, a trusted institution, termed a certificate authority, may issue key pairs to users. The certificate authority may rely on standard identifying documents, such as a driver's license and a passport, to verify that the correct identity is linked to the key pair. The public key of the user is then bundled into a digital certificate, which typically includes the user's public key and identifying information about the user. Some aspect of the digital certificate is frequently encrypted with the certificate authority's private key, which minimizes the possibility of modification or forgery. Therefore, the digital certificate provides others with confidence that the public key is correctly linked to an accurately identified user. The level of confidence of identification is generally proportional to the trust others place in the trusted authority.

The use of cryptography to prevent disclosure of a print job has been described. U.S. Pat. No. 5,633,932 issued to Davis et al., which is hereby incorporated by reference, involves encryption of a print job by a user with a printer's public key. The encrypted print job is thus assumed to be secure when sent by a user because its contents can only be decoded by a private key safely stored in the printer. Davis also describes an approach in which a cryptography-based exchange attempts to authenticate an intended recipient of a printed document when an intended recipient is physically proximate to the printer. However, Davis does not authenticate the identity of the sender that initially sends the print job to the printer. Thus, the scheme of Davis allows unverified users to send and print documents on the printer, providing no regulation of printer use. As a result, a method is still required in which the security offered by key pair cryptography regulates use of a printer. The present invention offers a readily implemented method for verifying the identity of a user that sends a print job to a printer.

### SUMMARY OF THE INVENTION

The present invention provides a method and system for regulating the ability of a user to print a document on a printer. A printer receives a print job from the user from a sending processor. The print job includes a representation of the document and an aspect encrypted with a private key of the user. The printer verifies the identity of the user by successfully decoding the aspect using a public key of the user. After the user is verified, the printer prints the document. The system may be configured to require re-verification of the user when the user is proximate to the printer.

### BRIEF DESCRIPTION OF THE FIGURES

FIG. 1 is an illustration of a system for regulating printing according to the present invention, showing a sending processor linked to a printer through a network.

FIG. 2 is a block diagram of the system of FIG. 1, showing locations of public and private keys.

FIG. 3 is a schematic illustration of a method for regulating printing according to the invention, showing encrypting, decoding, and verification steps carried out by a sending processor, a printer, a key server, and a portable processor.

FIG. 4 is a flowchart of a method for regulating output of a print job, based on a key pair of a user, according to the present invention.

### DETAILED DESCRIPTION OF THE INVENTION

The present invention provides a method and system for verifying the identity of a user sending a print job to a printer, based on asymmetric pair cryptography. Verification of the user regulates the activity of the printer. Without verification, and in some cases authorization, the printer does not print a document specified by the print job. Verification is required for the user at a sending processor and may be required again when the user is proximate to the printer.

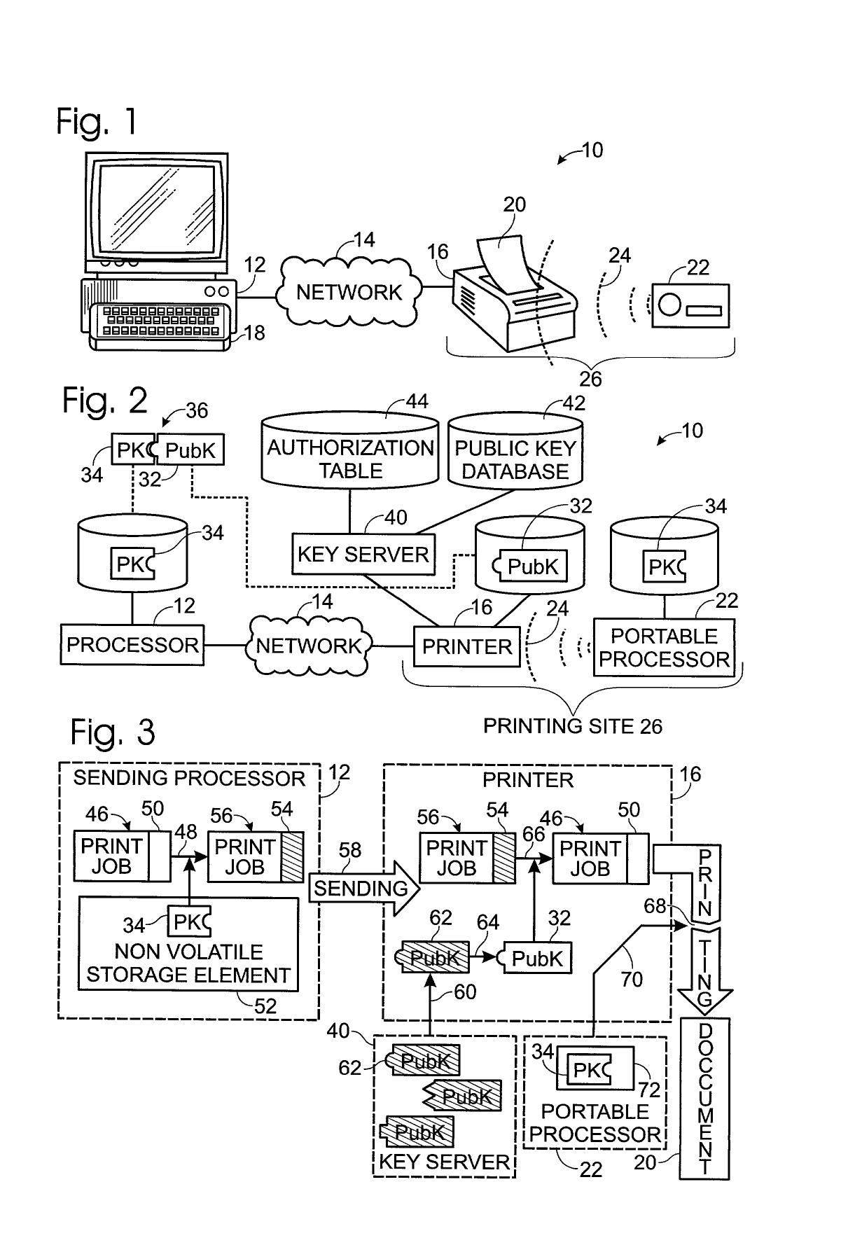

A network system configured to carry out the present invention is shown at 10 in FIG. 1. System 10 includes a sending processor 12 linked through a network 14 to a printer 16. Sending processor 12 sends a print job with an encrypted aspect. Typically, the print job is sent as a result of a command typed on a user interface 18 by the user. Printer 16 receives the encrypted print job from the network, verifies the user based on the encrypted aspect, and prints a document 20 that is specified by the print job. In some cases, the user is re-verified locally by printer 16, prior to printing. For example, portable processor 22 may be used to locally re-verify the user when the user is proximate to the printer. When re-verification is carried out, the user communicates with printer 16 using portable processor 22 to send a locally-restricted signal 24, such as by infrared radiation, to printer 16 at printing site 26. This allows the user to engage in a cryptographic exchange with printer 16 that re-verifies the user and allows printing of document 20.

Sending processor 12 is any device capable of receiving, storing, retrieving, manipulating, and sending data. Typically, processor 12 is a computer with memory, a processing unit (or units), and follows instructions, generally in the form of a computer program. Examples of processor 12 that may be suitable for use in the invention include a portable computer, such as a laptop computer, a personal digital assistant, or a cellular phone. Portable processor 22 may be equivalent to sending processor 12, when the sending processor is portable, or may be a processor that is distinct from the sending processor and is readily transported to printing site 26. Example of a portable processor include a laptop computer, a personal digital assistant, and a cellular phone with processing capabilities.

Network 14 is any system that allows communication between processor 12 and printer 16. Network 14 may be configured as a local area network, for example, a network within a company. Alternatively, network 14 may also be configured as a wide area network, which may be useful for the user when traveling away from home or office.

In the present invention, document 20 is data in any user-defined format, including text, symbols, tracings, drawings, images, or pictures.

FIG. 2 shows a block diagram of system 10 with locations of public key 32 and private key 34 of key pair 36 indicated. Public key (PubK) 32 and private key (PK) 34 form a corresponding key pair 36 that allows bi-directional encrypting and decoding as described above. The security of key pair 36 depends upon private key 34, which is not directly shared with printer 16 over network 14. Instead, private key 34 is maintained on sending processor 12 and may also be stored on portable processor 22. Typically, private key 34 is stored in non-volatile memory.

Decoding of encrypted data received from sending processor 12 by printer 16 requires public key 32. To obtain public key 32, printer 16 may be connected to a key server 40 that includes a public key database 42. Public key database 42 is any database with public keys that are accessible by printer 16. Key server 40 may be an administrative server on a local network that provides public keys only to printer 16 or to other locally connected printers. Alternatively, server 40 may act as a repository of public keys accessible over a wide area network by a large number of printers. In some cases, printer 16 may have obtained public key 32 from public key database 42 at a time prior to communication with the sending processor, or public key 32 may be have been directly loaded into memory of printer 16 by an individual responsible for managing the printer. In other examples, public key 32 may be sent from sending processor 12 by the user, for example, as part of the print job. Printer 16 determines or accepts the validity of public key 32 based on parameters provided by a person or group that manages printer 16.

In addition to determining the validity of public key 32, printer 16 may also determine if a user of public key 32 is authorized to send a print job to printer 16. Authorization table 44, stored on key server 40 or printer 16, may used in carrying out this determination. Authorization table 44 is any data structure that links public key 32 to a permission to print on printer 16. The permission may be distinct from both the validity of public key 32 and the ability of the user to prove possession of private key 34. In some cases, authorization may not be extended to a user initially, or authorization of a previously approved user may be revoked. These situations may occur, for example, if the user of a public key or the public key itself is not in good standing with a person, group, company, or institution that controls or manages use of printer 16, or when the user is not affiliated with the group, company, or institution.

FIG. 3 schematically illustrates a method for regulating printing according to the present invention, including steps carried out by sending processor 12, printer 16, key server 40, and portable processor 22. Before encryption, sending processor 12 prepares print job 46 for analysis by printer 16 (step not shown). The step of preparing typically includes converting a data file from a software-specific format to a form useable by printer 16, such as control source data. The converted data file is included in a body of the print job. Print job 46 also usually includes a header or control portion that gives printer 16 instructions about how to process and output the printable data.

During or subsequent to preparing print job 46, processor 12 encrypts (at 48) a portion or aspect 50 of print job 46 with private key 34, which may be stored on non-volatile storage element 52. This encryption step creates encrypted portion 54 in print job 56. The encrypted portion 54, shown as a hatched region of print job 56, may result from encryption of some or all of the header or the body of print job 46. Alternatively, the encrypted portion may be an encryption of an aspect of print job 46, such as encryption of a value that relates to or describes content of the print job. In the present illustration, aspect 50 may be a hash value produced from some or all of print job 46 using a one-way hashing function, such as a digital signature algorithm. Encryption of the hash value with private key 34 to produce encrypted portion 54 constitutes a digital signature. With use of the digital signature, encrypted print job 56 includes print job 46, which may not be encrypted, and the digital signature. In this case print job 46 and the digital signature may be communicated to printer 16 together in the print job, or separately.

Encryption with private key 34 helps provide security for use of printer 16. However it is not generally effective at preventing others from decoding encrypted print job 56, since public key 32 may be widely available. Therefore, some or all of print job 46 may additionally be encrypted with a public key of printer 16. This encryption would help to prevent others from decoding print job 56, because the private key of printer 16 would not generally be available to others.

Encrypted print job 56 is sent to printer 16 as indicated by large arrow 58 using network 14. Printer 16 receives encrypted print job 56 and obtains public key 32 to decode encrypted portion 54. Typically, print job 56 will include an identifier that allows printer 16 to request and receive public key 32 from public key database of key server 40, as shown at step 60, or to retrieve public key 32 from memory of printer 16 (step not shown). Alternatively, print job 56 may include public key 32. When public key 32 is provided by either sending processor 12 or key server 40, public key 32 is usually a digital certificate 62. Digital certificate 62 may include information that identifies the user and is typically signed or encrypted with a private key of a trusted authority. For example, an aspect of the digital certificate may be encrypted with the private key of key server 40 or the private key of a certificate authority that issued public key 32. Printer 16 may include a list of trusted authorities that will be accepted by printer 16, and their corresponding public keys. Validation of public key 32 in digital certificate 62 may be carried out as shown (at 64), by successfully decoding either a digital signature or another aspect of digital certificate 62 with a public key of the trusted authority. In some cases, availability or presence of public key 32 alone, without digital certificate 62, may be sufficient to ascertain validity.

When a valid public key 32 is obtained, printer 16 attempts to decode aspect or portion 54 and determines whether decryption was successful before proceeding (as shown at 66). For example, when a digital signature is used, printer 16 decodes an encrypted hash value to produce a hash value that was originally generated by a hash algorithm. The resulting hash value is compared with a hash value that is calculated by the printer from print job 46, using the hash algorithm. If the two values correspond, printer 16 considers the user verified. When decryption is successful, printer 16 may print document 20 directly. Alternatively, local re-verification of the user at the printing site may be selected by the user or may be a standard requirement for the printer. When local re-verification is used, the printer does not proceed to output of document 20, but instead waits for local re-verification of the user, as shown at step 68.

Re-verification, as shown at step 70, is conducted locally at printing site 26 using portable processor 22 that includes private key 34 in non-volatile memory 72. Private key 34 of portable processor 22 is identical to private key 34 of sending processor 12. The portable processor demonstrates possession of private key 34 to printer 16. This may be carried out by the portable processor through encrypting and sending a message that is decodable with public key 32 by printer 16, through decoding a message encrypted with public key 32 and sent by printer 16, or by a combination of these two steps. Portable processor 22 communicates with printer 16 using locally-restricted signal 24. Locally-restricted signal 24 is any signal that is substantially restricted to printing site 26, and is typically any optical signal that cannot efficiently travel outside of printing site 26.

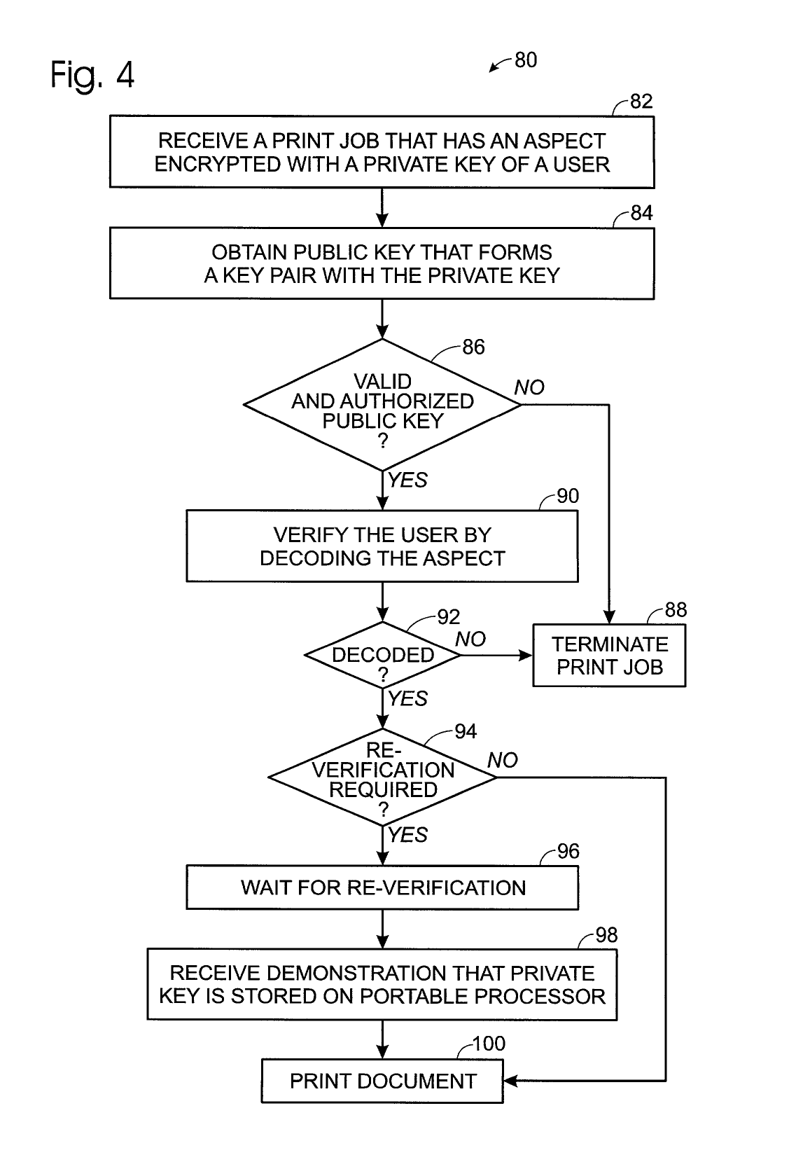

FIG. 4 is a flowchart of a method 80 for regulating output of a print job, based on a key pair of a user, according to the present invention. The printer receives a print job that has an aspect encrypted with a private key of a user, as shown at 82. Based on contents of the print job, the printer obtains a public key that forms a key pair with a private key, shown at 84. Typically, the contents include an identifier to allow the printer to obtain a public key, or the contents include the public key itself. Once the printer obtains a valid (and authorized) public key, the public key may be used in subsequent steps of method 80. However, as shown at 86, if the printer is unable to obtain the public key altogether, or the public key, once obtained, is determined to be invalid or not issued to an authorized user of the printer, the print job is terminated, as shown at 88. Using a valid public key, the printer verifies the user by decoding an encrypted aspect, as shown at 90. The printer then determines if decoding was successful at 92. When the encrypted aspect corresponds to a digital signature, successful decoding will produce a correct hash value for the print job. If decoding is not successful, printing is terminated, at 88.

Based on either a user input present in print job 46, a user input specified separately by the user, or input otherwise placed into printer 16, printer will determine if re-verification is required, as shown at step 94. When re-verification is not required, printer will print document as shown at step 100. However, if re-verification is required, printer will wait for re-verification and postpone printing, as indicated at step 96. When the user is present at printing site 26, portable processor 22 may be used to signal printer 16 that the user is ready for re-verification. After printer 16 receives a demonstration that private key 34 is stored on portable processor, as shown at step 98, printer 16 prints document, as shown at step 100.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

I claim:

1. A method for regulating the ability of a user to print on a printer, comprising the steps of:
receiving, at a printer, a print job from a user, where the print job includes a representation of a document and an aspect of the print job that is encrypted with a private key of the user;
verifying the user by decoding the aspect using a public key of the user, where the public key and the private key form a key pair; and
printing the document on the printer if the user is a verified user.

2. The method of claim 1, where the printer is located at a printing site and printing is contingent on re-verification of the user at the printing site.

3. The method of claim 2, where re-verification includes demonstrating possession of the private key by the user at the printing site.

4. The method of claim 3, where the private key is stored on a portable processor and possession is demonstrated with a locally-restricted optical signal.

5. The method of claim 1, where the aspect relates to content of the print job.

6. The method of claim 1, where the aspect, after encryption, is a digital signature.

7. The method of claim 1, where the public key is included in a digital certificate.

8. The method of claim 1, where the public key is included in the print job.

9. The method of claim 1, where the public key is obtained by the printer from a public key database.

10. The method of claim 1, where the public key is linked to an authorization table that permits the user to print on the printer.

11. The method of claim 1, where the print job is at least partially encrypted by the user with a public key of the printer.

12. A system for regulating the ability of a user to print on a printer, comprising:
a sending processor that includes a private key of a user, where the private key forms a key pair with a public key, the sending processor being adapted to encrypt an aspect of a print job using the private key and to send the print job and encrypted aspect over a network; and
a printer in communication with the sending processor, where the printer is adapted to receive the print job and encrypted aspect from the sending processor, to verify the user by decoding the encrypted aspect using the public key, and to print a document based on the print job if the user is a verified user.

13. The system of claim 12, where the printer is located at a printing site and the user is verified upon a demonstration that the user possesses the private key at the printing site.

14. The system of claim 12, further including a portable processor that stores the private key in memory and carries out the demonstration.

15. The system of claim 12, where the aspect relates to content of the print job.

16. The system of claim 12, where the aspect, after encryption, is a digital signature.

17. The system of claim 12, where the public key is included in a digital certificate.

18. The system of claim 12, where the public key is included in the print job.

19. The system of claim 12, where the public key is obtained by the printer from a public key database.

20. The system of claim 12, where the public key is linked to an authorization table that permits the user to print on the printer.

21. The system of claim 12, where the print job is at least partially encrypted with a public key of the printer.

22. A printer capable of regulating output of a print job from a user, comprising:
a printer in communication with a user and adapted to receive a print job that has an aspect encrypted with a private key of the user, to verify the user by decoding the aspect using a public key of the user that forms a key pair with the private key, and to output the print job based on verifying the user.

23. The printer of claim 22, where the printer is located at a printing site and is further adapted to re-verify the user by receiving a demonstration that the user possesses the private key at the printing site.

24. The printer of claim 23, where printer is adapted to receive the demonstration from a portable processor that stores the private key in memory.

25. The printer of claim 22, where the aspect relates to content of the print job.

26. The printer of claim 22, where the aspect, after encryption, is a digital signature.

27. The printer of claim 22, where the public key is included in a digital certificate.

28. The printer of claim 22, where the public key is included in the print job.

29. The printer of claim 22, where the public key is obtained by the printer from a public key database.
